(19) United States
(12) Patent Application Publication
(10) Pub. No.: US 2002/0017099 A1
(43) Pub. Date: Feb. 14, 2002

(54) Thermal engine

(76) Inventor: Glenn Alexander Thompson, Orange (AU)

Correspondence Address: Lowell Anderson, Stetina Brunda Garred & Brucker, 75 Enterprise, Suite 250, Aliso Viejo, CA, 92656, US

(21) Appl. No.: 09/779,052

(22) Filed: Feb. 6, 2001

(30) Foreign Application Priority Data
Aug. 6, 1998 (AU) PP5083
Dec. 7, 1998 (AU) PP7556

(51) Int. Cl. F02G 1/00; F01K 1/00

(52) U.S. Cl. 60/597; 60/670

(57) ABSTRACT

A thermal engine including a positive displacement compressor (A) having at least one rotatable vane partly defining at least one of the variable chambers within the compressor (A) having at least one rotatable vane partly defining at least one of the variable volume chambers within the compressor, a thermal chamber (D) in fluid communication with the outlet of the compressor (A), the thermal chamber (D) having heat transfer means for transferring heat from a heat source to the working fluid; and a positive displacement motor (B) having at least one rotatable vane partly defining at least one of the variable volume chambers within the motor and drive means for driving the compressor and an external load wherein, in use the flow of working fluid through the thermal chamber is substantially continuous.

The present invention relates to engines generally and in particular to thermal engines utilising a heat source and/or a heat sink.

Many types of engine have been developed in order to convert the energy from a heat source into mechanical power. The heat source is commonly provided by the combustion of a fuel which is used to transfer heat to a working fluid which is used to drive machinery such as pistons or turbines in order to produce readily useable mechanical power. An example of this is the standard spark ignition internal combustion engine. The working fluid (usually air) is heated to drive reciprocating cylinders. Similarly coal fired power stations will commonly use super heated steam to drive steam turbines in order to power the generators.

The thermal efficiency of these engines is affected by the process of transferring the heat of combustion to the working fluid and then maximising the work available in expanding the working fluid before it is exhausted from the engine. The reciprocating piston style of internal combustion engine has proved to be a very useful general purpose engine which has found wide application in many fields of industry. However, its traditional design has many characteristics which are inherently thermally inefficient. Induction, compression and combustion of the working fluid occur in the same chamber giving rise to high thermal gradients. Furthermore, the fuel combusts at an essentially constant volume within the cylinder which leads to extreme initial pressures and temperatures and consequently, high levels of heat loss. Also the combustion occurs in contact with an essentially cool metal chamber with the resultant quenching and incomplete combustion of the fuel together with heat losses from the working fluid. In many engine designs, the final part of the compression stroke occurs against the pressure of the initial stages of combustion which detracts from the engines overall efficiency. Also the expansion ratio is limited to the mechanical configuration of the machine used. The spark ignition type of engine also suffers from inherent mechanical inefficiencies because of the many load bearing seals and load bearing sliding surfaces. The resultant friction generates heat which is usually wasted as it is necessarily dissipated to the environment by a radiator or cooling fins.

These inefficiencies are common to spark ignition engines using “positive displacement” motors and/or compressors. Positive displacement machinery provide one or more defined chambers which can be varied in volume. In the case of a positive displacement compressor the volume within the chamber is reduced by a defined amount in order to compress the working fluid. In a positive displacement motor the working fluid acts to increase the volume within the chamber from a predetermined minimum to a predetennined maximum such that a defined volume is displaced. Despite their inefficiencies, positive displacement motors and compressors are effective over a broad range of engine speeds. This allows the engine to be used in many general purpose applications that have loads requiring significant torque at relatively low speeds as well as relatively high speeds.

The gas turbine avoids the use of positive displacement compressors or motors. Gas turbines are often used in applications such as aircraft jet engines. Instead of positive displacement machinery, the working fluid is compressed using high speed turbine blades or vanes. Fuel is combusted in the compressed working fluid, and then expanded through the turbine blades or vanes to drive the expansion turbine. The expansion turbine drives the compressor turbine and as the air continues to expand through exhaust nozzle, the flow velocity increases to produce forward thrust.

The modern gas turbine is well suited to many applications, however, some of its inherent characteristics preclude it from becoming a general purpose engine. The gas turbine is primarily a high speed engine which is not able to develop adequate torque over a wide range of speed settings. Furthermore, the gas turbine engines are subject to compressor stall, flame out and other disadvantages if handled poorly. In addition, its operational efficiency is limited by metallurgical considerations because the products of combustion may often need cooling before they enter the expansion turbine.

Another type of general purpose engine is commonly known as a Joule's engine. Like the gas turbine, the Joule's engine provides a motor connected in tandem with a compressor. However, as the Joule's design uses reciprocating cylinders instead of turbine blades, it can provide useable torque at lower speeds as well as relatively high speeds.

Despite the broader range of speeds available from the Joule's engine, it also suffers from a number of inherent disadvantages. Firstly, to provide a continuous flow of working fluid through the engine, the compressor and motor must each have at least two reciprocating cylinders. The complex manifolds and valve porting arrangement that this necessarily requires, adversely affects the thermal efficiency. The extra manifolds and valves dissipate more heat from the working fluid which lowers the work output from the motor. Also, as discussed above, the friction from the sliding seals within the cylinders lead to further inefficiencies.

The manifold arrangement can be minimised by using a single cylinder compressor and a single cylinder motor. However, this will necessarily result in intermittent flow of the working fluid through the engine. Intermittent working fluid flow will not readily support continuous internal combustion of the fuel. The fuel is combusted as each fresh charge of working fluid enters the combustion chamber. This allows thermal gradients to form within the walls of the chamber and can also lead to the inefficient combustion of fuel. Alternatively, the engine can use external combustion of the fuel and heat the working fluid by a heat exchanger of some type. However, the heat loss and other inefficiencies of the heat exchanger contribute to the inefficiency of the engine as a whole.

It is an object of the present invention to overcome or ameliorate some of the disadvantages of the prior art or at least provide a useful alternative.

According to a first aspect the present invention provides a thermal engine including:

a positive displacement compressor having at least one rotatable vane partly defining at least one of the variable volume chambers within the compressor,

a thermal chamber in fluid communication with the outlet of the compressor,

the thermal chamber having heat transfer means for transferring heat from a heat source to the working fluid; and,

a positive displacement motor having at least one rotatable vane partly defining at least one of the variable volume chambers within the motor and drive means for driving the compressor and an external load,

wherein, in use the flow of working fluid through the thermal chamber is substantially continuous.

In one embodiment, the working fluid is air and the thermal chamber is a combustion chamber wherein the heat transfer means is an arrangement for the continuous internal combustion of fuel. Preferably, the compressor outlet has a one way valve for unidirectional flow from the compressor to the thermal chamber, In a preferred form, the combustion chamber is configured such that the air is split into first and second streams, wherein the first stream supports the combustion of the fuel and the second stream bypasses the combustion process and recombines with the first stream before entering the motor. The flow of working fluid to the combustion process may be set at a level ensuring complete combustion of the fuel.

In another embodiment of the heat transfer means there is an arrangement for transferring heat from a heat source external to the thermal chamber to the working fluid. A further embodiment involves the heat transfer means arranged to transfer heat from the working fluid to a heat sink in order to cause the, engine to operate in reverse wherein working fluid flows from the motor to the compressor.

In a another particular form, the positive displacement compressor and motor each include:

a spherical housing having an inlet and an outlet,

a rotatable disk mounted within the housing for rotation about a drive shaft such that a peripheral portion of the disk slidably seals against the internal surface of the housing, wherein the axis of the drive shaft extends along a diameter of the rotatable disks;

a pair of semi-circular vanes mounted within the housing on either face of the rotatable disk such that the vanes are coplanar and adapted for rotation within their common plane about a central axis normal to the common plane wherein the periphery of the vanes slidably seal against the internal surface of the housing and the rotatable disk;

the axis of the drive shaft is disposed at an angle to the central axis of the vanes such that the housing is divided into four chambers that cyclically vary in volume as the rotatable disk rotates about the drive shaft; and,

the inlet and outlet are configured such that in use, the inlet is in fluid communication with at least one of the chambers when its volume is increasing and the outlet is in fluid communication with at least one chamber when its volume is decreasing.

In this form of the present invention, it is preferable that the inlet opens to a chamber when its volume is at its minimum, and closes when its volume is at its maximum, and the outlet opens to a chamber when its volume is at its maximum and closes when at its minimum. Furthermore, the semi-circular vanes may have a wedge configuration wherein the apex of the wedge slidably seals against the rotatable disk and the wide portion of the wedge sidably seals against the internal surface of the spherical housing.

According to a second aspect, the present invention provides a positive displacement motor including:

an outer casing having internal partition means defining a high pressure zone and a low pressure zone within the casing and a casing inlet and casing outlet in fluid communication with the high and low pressure zones respectively;

an inner housing rotatably mounted within the outer casing, the inner housing having a coupling means for operative connection to a drive shaft and an at least partially spherical cavity disposed within the housing such that a central axis of the cavity is colinear with the axis of rotation of the housing, the cavity having a cavity inlet and cavity outlet in fluid communication with the high pressure zone and low pressure zone respectively and a disk mounted within the inner housing such that the plane of the disk is inclined to the axis of rotation of the inner housing and the centre of the cavity is within the plane of the disk;

a mast fixed relative to the outer casing and extending into the cavity, the free end of the mast having a hinge arrangement wherein the hinge axis intersects the center of the cavity, a generally planar semi-circular vane hinged to the hinge arrangement such that the axis of rotation of the inner housing is within with the plane of the vane and the hinge axis is normal to the plane of the vane wherein the diameter of the semi-circular vane is substantially equal to the diameter of the at least partially spherical cavity;

the vane engages the disk along a diameter of the disk and the diameter of the disk is substantially equal to the diameter of the spherical cavity such that the disk and the vane define two chambers within the cavity that cyclically vary in volume with rotation of the housing;

wherein the cavity inlet and cavity outlet are positioned relative to the bearing means such that in use, the cavity inlet is in fluid communication with one of the chambers as its volume is increasing and the cavity outlet is in fluid communication with the other chamber as its volume is decreasing.

It will be appreciated that a motor according to this aspect of the invention is suitable for use as a compressor wherein the drive shaft rotates the inner housing such that the compressor inlet communicates with the low pressure zone of the outer casing and the compressor outlet communicates with the high pressure zone of the outer casing.

In one preferred form the cavity includes bearing means to mount the disk within the cavity for relative rotation with the inner housing. In this embodiment the disk is preferably hinged to the vane such that the hinge axis is co-linear with the diameter of the semicircular vane.

Preferably, the disk and the vane do not engage the internal surface of the spherical cavity. In a further preferred form, the disk includes wedge formations provided on either side of the vane such that the apex of the wedge formation is proximate the hinge connection with the vane.

Preferably the cavity inlet and outlet open to the variable volume chambers when the chambers are at their minimum and maximum volumes respectively, In this embodiment the cavity inlet and outlet are in the plane defined by the axis of rotation of the inner housing and the diameter of the disk that intersects the axis of rotation of the inner housing at right angles.

One particularly preferred embodiment of the thermal engine according to the present invention uses a positive displacement compressor and a positive displacement motor as described above.

The invention will now be described by way of example only with reference to the accompanying drawings, in which:

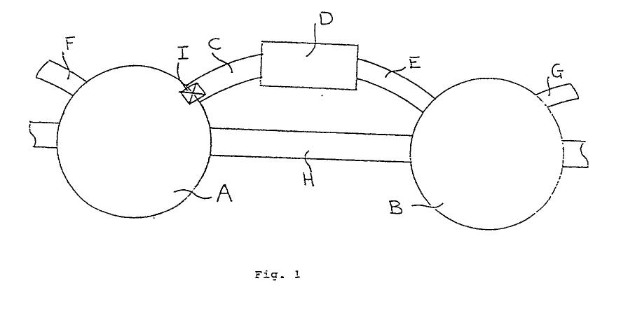

FIG. 1 is a schematic layout of the components of the thermal engine according to the present invention;

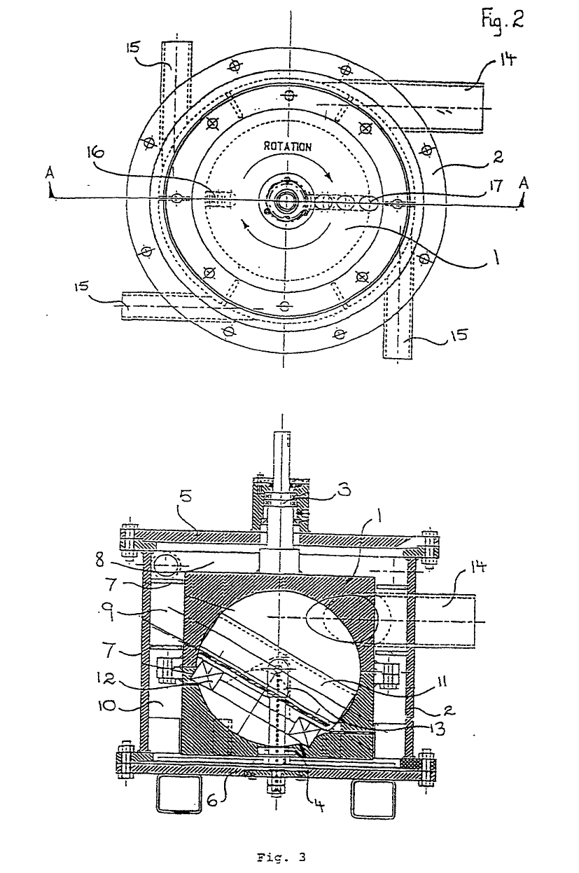

FIG. 2 is the plane view of a motor or compressor for use in a thermal engine according to the present invention;

FIG. 3 is a sectional view of the motor or compressor shown in FIG. 2;

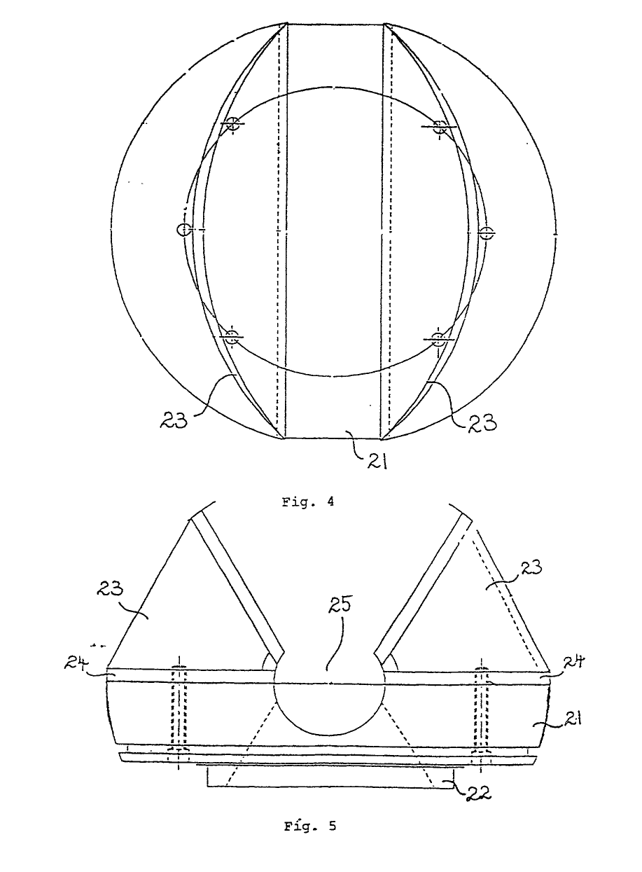

FIG. 4 shows the plane view of the rotatable disk mounted within the motor or compressor shown in FIG. 2;

FIG. 5 is a slide elevation of the rotatable disk mounted within the motor or compressor shown in FIG. 2;

FIG. 6 is a plane view of the rotating vane mounted within the motor or compressor shown in FIG. 2;

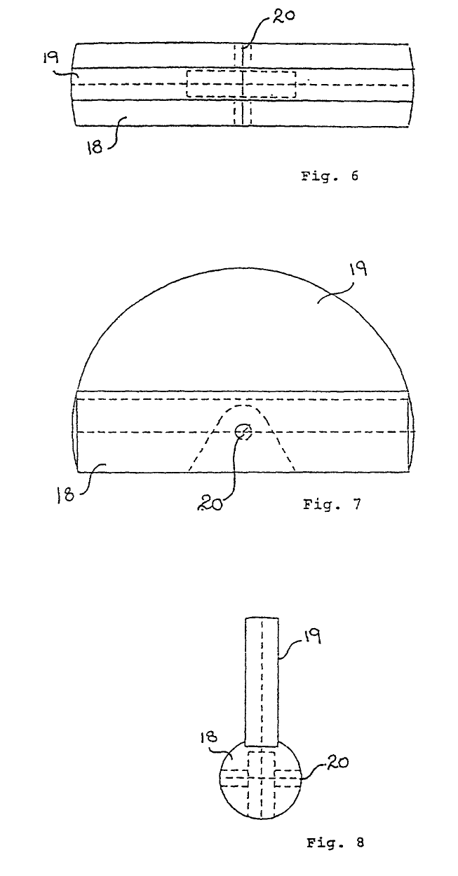

FIG. 7 is a front elevation of the vane mounted in the motor or compressor shown in FIG. 2;

FIG. 8 is an end elevation of the vane mounted in the motor or compressor shown in FIG. 2.

With reference to FIG. 1, the positive displacement compressor (A) is mechanically linked to the positive displacement motor (B) via shaft (H). A working fluid such as air is drawn into the compressor (A) and delivered to the outlet valve (I) at a relatively high pressure. Outlet valve (I) is a non-return valve which ensures unidirectional flow of the working fluid from the compressor to conduit (C). Conduit (C) delivers the working fluid to combustion chamber (D). Combustion chamber (D) includes coaxial inner and outer tubes (not shown) such that the working fluid is divided into two streams. A first stream passes through the inner tube with the remainder of the working fluid forming a second stream passing through the outer tube. The inner tube is provided with an arrangement (not shown) for continuously combusting a combustible fuel. The flow rate of fuel to the combustion chamber may be selectively varied by a throttling arrangement (not shown). Ignition means such as a spark plug or similar arrangement (not shown) is provided in the inner tube to ignite or re-ignite the fuel in the event that combustion unintentionally ceases.

A first stream of working fluid passing within the inner tube is subject to heating an expansion from the combustion of the fuel. The working fluid from the inner tube and the working fluid from the outer tube mix in conduit (E) before entering the motor (B).

Positive displacement compressor (A) preferably has the highest possible ratio of maximum volume to minimum volume within its variable volume chambers in order to ensure efficient transfer of the working fluid into conduit (C). The compressor (A) may have a plurality of compression chambers which are phased so as to provided an essentially constant flow of working fluid into conduit (C). However, the compressor (A) and motor (B) both employ a rotating vane style design to avoid the complex manifold and valve arrangements required by designs using two or more reciprocating cylinders. To further smooth the flow rate from the compressor the conduit (C) may be sized such that its volume pneumatically compensates for any intermittent flow from the compressor (A). This may be achieved by effectively forming pipe (C) into (A) compressed air reservoir with its outlet being a delivery to combustion chamber (D).

To enhance efficiencies, a cross flow heat exchanger may be installed between the outlet of conduit (C) and the combustion chamber (D) in order to recover some of the heat from the working fluid as it is exhausted from the motor (B). In order to maximise the expansion of the working fluid, the heat exchanger transfers heat to the stream of working fluid passing through the outer tube only. The stream passing through the inner tube is heated by the combustion of the fuel but not preheated by the heat exchanger.

Combustion of the fuel within combustion chamber (D) raises the temperature and specific volume of the working fluid which flows through conduit (E) to drive the positive displacement motor (B). Of course, motor (B) will have a mechanical advantage over compressor (A) in order to provide the power required to drive the compressor as well as the designated load (not shown). The mechanical advantage of motor (B) over compressor (A) may be achieved by a difference in physical displacement and/or the mean pressure of compression being lower than the mean pressure within the motor. Alternatively, mechanical advantage may be provided by gearing or other means which would be readily apparent to any ordinary worker in this field.

The, thermal engine according to the present invention may use positive displacement compressors and motors in accordance with many well known designs using vanes and/or disks. However, the advantages of the engine are enhanced if the frictional and mechanical losses within the motor and compressor are minimised. Accordingly, the arrangement shown in FIGS. 2 to 8 provide a compressor and motor design with minimal losses to friction and other mechanical inefficiencies.

With reference to FIG. 3 a spherical chamber is formed within a solid cylindrical body 1. Body 1 is rotatably mounted within a hollow cylindrical casing 2 by means of bearings 3 and 4 which are supported by cylindrical casing top cover 5 and bottom cover 6. Two baffle plates or dividers 7 which are fixed to the cylindrical casing and have central holes formed within them so as to permit the location of the body 1 with a minimum of clearance. The baffles 7 together with the cylindrical casing 2 and body 1 form chambers 8, 9 and 10 within the cylindrical casing. A vane disk and core assembly 11 is located within the spherical chamber and located by and supported on bearing 12.

With reference to FIGS. 4, 5, 6, 7 and 8 assembly 11 consists of essentially a disk 21 with a locating extension 22 which fits inside bearing 12 and fillers 23 which have no function other than to occupy volume. Fillers 23 are thermally insulated from disk 21 by integral insulative material 24. Core 18 is in the form of a rod with circular section and is rotatably mounted within slot 25 which is formed in the disk 21. Core 18 has a longitudinal slot cut into it to permit the fixing of vane 19 to core 18. Assembly 1 defines two chambers within one hemisphere of the spherical chamber. Both the disk 21 and vane 19 have radii which are slightly smaller than the radius of the spherical chamber so that there is no sealing relationship and no friction. Core 18 also has longitudinal dimension slightly smaller than the spherical chamber diameter. Assembly 11 is held in place by means of a pin through hole 20 and a hole in the top of mast 13. Mast 13 is fixed to bottom cover 6.

With rotation of body 1, the central axis of disk 21, which is set at an angle to the axis of body 1, rotates around the axis of body 1. Core 18 rocks around the central diametric axis fixed by the pin passing through it but core 18 does not rotate around its longitudinal axis. Disk 21 does not rotate. Rotation of body 1 therefore causes the two chambers defined within one hemisphere by assembly 11 to cyclically vary in volume. Inlet ports 16 are provided in the side wall of body 1 so as to communicate the spherical chamber with chamber 9. Outlet ports 17 are provided in the top surface of body 1 so as to communicate the spherical chamber with chamber 8. With rotation of body 1 inlet ports 16 are in repetitious sequential communication with each of the variable volume chambers defined by assembly 11 during the period during which they are increasing in volume while the outlet ports 17 are also in repetitious communication with each of the variable volume chambers during the period in which they are decreasing in volume. A working fluid introduced under pressure through pipe 14 into chamber 9 will flow in through inlet ports 16 to exert a pressure on the surfaces defining the variable volume chambers as they repetitiously communicate with inlet port 16. Pressure on the face of that portion of disk 21 which is within the variable volume chamber which is in communication with inlet port 16 will be transmitted to bearing 12 and in turn body 1 with the result that body 1 will rotate. Rotation of body 1 will cause the volume of the variable volume chamber which is in communication with the inlet ports 16 to increase to the point where it reaches its maximum volume. At that time the inlet ports pass the perimeter of vane 19 and in turn begin communication with the other variable volume chamber. Concurrently the exhaust ports 17 communicate with the variable volume chamber which has completed increasing in volume and has begun to decrease in volume. With further rotation under the influence of pressure being introduced to the other variable volume chamber the working fluid is expelled through outlet ports 17 into chamber 8. The expelled working fluid subsequently flows out of chamber 8 through pipes 15.

This configuration has the advantage of providing a mechanism with variable volume chambers where there is no load bearing sliding surfaces, additionally there are no sliding sealing surfaces with the result that beyond the friction provided by ball bearing 12 there is no friction. With no load bearing sliding surfaces and no sliding sealing surfaces the motor is capable of running at high speed and high temperature. The need for cooling at expected operating temperatures up to several hundred degrees centigrade is dispensed with insofar as surfaces which contact the working fluid are concerned.

The exterior surfaces of cylindrical casing 2 including the top cover 5 and bottom cover 6 may be insulated against heat loss. Cooling and lubricating oil is circulated through an external heat exchanger in order to cool the oil. Oil is passed over hearings 4 and 12 by pumping oil up through the centre of mast 13 to lubricate the pin. Mast 12 has an oil hole in the side of it positioned such that oil is directed onto bearing 12. Rotation of body 1 together with movement of the various components in that part of the spherical chamber which is below assembly I1 cause the distribution of oil generally in the lower hemisphere with a cooling effect on the bottom of the disk in the region where core 18 is in contact with disk slot 25. Several holes in the bottom of disk slot 25 also enable lubrication of the disk slot 25 where it is in sliding contact with core 18. The oil cools the lower part of body 1 generally.

There is no load on the surfaces beyond the light load between the surfaces of core 18 and disk slot 25 that is provided by the low tension applied to the nuts holding mast 13 so as to maintain assembly 11 in location. Oil introduced into the lower portion of the spherical chamber is expelled into chamber 10 by the operation of centrifigal force which causes the oil to flow out through horizontal holes drilled in the lower part of body 1. The oil is drawn from the lower part of chamber 10 for recirculation. Bearing 11 is cooled and lubricated by a flow of oil through the bearing housing. As there is no sealing relationship between assembly 11 and the walls of the spherical chamber within body 1 there will be leakage of the working fluid. Leakage is proportionate to both pressure and time, the present engine provides for both low constant pressure and high velocity of working fluid with the result that the loss of efficiency due to leakage is less than that which would be lost to friction and the need to cool the mechanism. An oil control ring is provided near the lower edge of disk 21.

The above described mechanism provides the motor for the presently described engine. Two mechanisms of identical construction may be provided for the compressor with the exception that they rotate and operate in the reverse sense such that inlet pipe 14 of the motor acts as an outlet on the compressor and outlet pipe 15 of the motor act as inlet pipe on the compressor with similar reverse relationships with ports 16 and 17.

The above described motor and compressor are mounted on a single chassis. A shaft with worm drive at both ends is connected to the drive shaft of the motor and the compressor so that the compressor and motor rotate at uniform speed but opposite directions. The compressor has a total displacement of one fourth of the displacement of the motor. The compressor is arranged so as to provide an essentially continuous flow of compressed working fluid.

The outlet pipe of the compressor communicates with a pipe having a volume of approximately 40 times the volume of the compressor. This volume is not critical as its purpose is to provide a pneumatic buffer to the cyclic and sinusoidal nature of the fresh charges of working fluid introduced by the compressor. This pipe in turn communicates with a combustion chamber consisting of two co-axial tubes configured such that the flow of working fluid is divided into two steams. One passes through the centre tube and the other passes outside the centre tube within the outer tube. The inner tube and the outer tube have parallel sides and sections such that equal volumes of working fluid pass into each stream. Part way along the length of the inner tube, a fuel supply tube introduces fuel into the centre of the inner tube and a metering device controls the rate of fuel flow. One or more pairs of electrodes are placed adjacent the fuel outlet such that a spark may be passed through or in close proximity to the fuel flow to initiate combustion. In normal operation, the electrodes would continuously provide spark so as to re-initiate combustion should it be unintentionally interrupted by whatever cause. The length of the inner tube, and therefore the outer tube are such that expansion of the working fluid passing within the inner tube is completed within the inner tube to ensure that no heat is communicated to cooler working fluid or engine surfaces before expansion is complete. An inner tube length of approximately three times the maximum flame length is provided. The inner tube is coated externally with a ceramic or other convenient coating with low thermal conductivity properties. The combustion chamber is then communicated with a further pipe leading to the inlet pipe of the motor. This pipe is insulated against heat loss. Initially the two streams of working fluid from the combustion chamber flow as two co-axial streams with different velocities. The differential velocities ensure rapid mixing of the two streams occurs downstream from the combustion chamber. The pipe leading from the combustion chamber is communicated with the inlet pipe of the motor and the working process continues as described above.

Starting means are provided by providing a separate pressure tank (not shown) which is initially charged with compressed air from an external source, the charge is then maintained by bleeding a proportion of the working fluid from the compressor during normal operation until the pressure within the tank is at approximately 40 lb per square inch. A pipe is provided between the tank and the pipe of the engine between the compressors and the combustion chamber, a tap is also provided so as to open and close a flow of compressed air from the tank to the pipe of the engine. Starting is provided by opening the tap so as to introduce a flow of compressed air though the combustion chamber and partially pressurising the system, once a flow is established through the combustion chamber combustion may be initiated whereupon the tap between the pressure tank and the pipes of the engine is closed whereupon normal operation will continue.

Those skilled in the art will appreciate that without departing from the scope of the invention many variations of the engine described are possible for example in respect to the motor the assembly 11 may be rotatively mounted within the spherical chamber of body 1 so that in operation body 1 is stationary and a drive shaft is taken from the axis of vane 19, the casing 2 may be omitted entirely and inlet and outlet pipes be connected to ports 16 and 17, seals may be included. In an entirely different form the compressor or motor may be reciprocating type or any other form of compressor and or motor which may be configured to enable the characteristics disclosed in this specification. In other variations the inner pipe which is coaxial with the combustion tube may be formed so as to expand in the direction of flow of the working fluid and the combustion chamber may be modified in shape so as to vary the velocities of working fluids. Many other variations too numerous to set out are possible.

Those skilled in the art will appreciate that without departing from the scope of the invention internal combustion may be augmented by or entirely replaced by some other heat source. By way of non limiting example, infra red radiation could be transmitted via optical fibre so as to heat a black body within the piping associated with the engine so as to in turn heat the working fluid. Such an arrangement may be included between the compressor and the combustion chamber in which case the working fluid would be divided into two streams before the combustion chamber so that the stream which is to become subject to internal combustion is not heated by the presently discussed method and the stream that is so heated directed outside the inner tube of the combustion chamber. If the presently discussed method is to be used in conjunction with the both internal combustion and a heat exchanger for lost heat recovery as described above the working fluid could be divided into three steams, the underlying principle being that in order to make use of the largest possible temperature range for heat absorption a stream of working fluid should be heated by one heat source only.

1. A thermal engine including:
a positive displacement compressor having a compressor housing with a bearing means;
at least one rotatable vane mounted within the housing on the bearing means for relative rotation between the housing and the vane;
a thermal chamber in fluid communication with the outlet of the compressor,
the thermal chamber having heat transfer means for transferring heat from a heat source to the working fluid; and,
a positive displacement motor for driving the compressor and an external load, the motor having a motor housing with a bearing means;
at least one rotatable vane mounted within the housing on the bearing means to allow relative rotation between the motor housing and the vane wherein,
in use the flow of working fluid through the thermal chamber is substantially continuous and none of the vanes within the motor or the compressor form a load bearing sliding seal.

2. A thermal engine according to claim 1 wherein the working fluid is air, the thermal chamber is a combustion chamber and the heat transfer means is an arrangement for the continuous internal combustion of fuel.

3. A thermal engine according to claim 2, wherein the compressor outlet has a one way valve for unidirectional flow from the compressor to the thermal chamber.

4. A thermal engine according to claim 2, wherein the combustion chamber is configured such that the air is split into first and second streams wherein the first stream supports the combustion of the fuel and the second stream bypasses the combustion process and recombines with the first stream before entering the motor.

5. A thermal engine according to claim 4, wherein the flow of working fluid to the combustion process is set at a level ensuring complete combustion of the fuel.

6. A thermal engine according to claim 1, wherein the heat transfer means is an arrangement for transferring heat from a heat source external to the thermal chamber to the working fluid.

7. A thermal engine according to claim 1, wherein the heat transfer means is arranged to transfer heat from the working fluid to a heat sink in order to cause the engine to operate in reverse wherein working fluid flows from the motor to the compressor.

8. A thermal engine according to claim 1, wherein the compressor housing and motor housing are both spherical housings, each having:
an inlet and an outlet,
a rotatable disk mounted within the housing for rotation about a drive shaft wherein the axis of the drive shaft extends along a diameter of the rotatable disk,
a pair of semi-circular vanes mounted on the bearing means within tho housing, the semi-circular vanes extending from either face of the rotatable disk such that the vanes are coplanar and adapted for rotation within their common plane about a central axis normal to the common plane; the axis of the drive shaft is disposed at an angle to the central axis of the vanes such that the housing is divided into at least two chambers that cyclically vary in volume as the rotatable disk rotates relative to the drive shaft; and,
the inlet and outlet are configured such that in use, the inlet is in fluid communication with at least one of the chambers when its volume is increasing and the outlet is in fluid communication with at least one chamber when its volume is decreasing.

9. A thermal engine according to claim 8, wherein the bearing means is an axial thrust bearing race; and
the inlet opens to one of the chambers when its volume is at its minimum, and
closes when its volume is at its maximum, and the outlet opens to one of the chambers when its volume is at its maximum and closes when at its minimum.

10. A thermal engine according to claim 8 wherein the semi-circular vanes have a wedge configuration wherein the apex of the wedge slidably contacts the rotatable disk.

11. A positive displacement motor including:
an outer casing having internal partition means defining a high pressure zone and a low pressure zone within the casing and a casing inlet and casing outlet in fluid communication with the high and low pressure zones respectively;
an inner housing rotatably mounted within the outer casing, the inner housing having a coupling means for operative connection to a drive shaft and an at least partially spherical cavity disposed within the housing such that a central axis of the cavity is colinear with the axis of rotation of the housing, the cavity having a cavity inlet and cavity outlet in fluid communication with the high pressure zone and low pressure zone respectively;
at least three rotatable vanes mounted within the cavity to define at least two variable volume chambers, one of tho three vanes being a central vane rotatably mounted within the cavity for rotation about an axis normal to the plane of the central vane;
the remaining two vanes being side vanes mounted either side of the central vane for rotation about a common axis that passes through the centre of the cavity and the plane of the central vane, the common axis being inclined to the axis of rotation of the inner housing:
the inner housing further having bearing means for relative rotation between the side vanes and the inner housing such that the reactive forces between the side vanes and the inner housing are transferred through the bearing means;
wherein the cavity inlet and cavity outlet are positioned relative to the bearing means such that in use, the cavity inlet is in fluid communication with one of the chambers as its volume is increasing and the cavity outlet is in fluid communication with the other chamber as its volume is decreasing.

12. A positive displacement motor according to claim 11, wherein it is suitable for use as a compressor wherein the drive shaft rotates the inner housing such that the compressor inlet communicates with the low pressure zone of the outer casing and the compressor outlet communicates with the high pressure zone of the outer casing.

13. A positive displacement motor according to claim 11 wherein the bearing means is an axial thrust bearing race.

14. A positive displacement motor according to claim 13, wherein the side vanes are provided by a disk such that one half of the disk is one side vane and the other half is the second side vane, wherein the disk is hinged to the central vane such that the hinge axis is co-linear with the diameter of the central vane.

15. A positive displacement motor according to claim 11, wherein the respective peripheries of the disk and the central vane do not engage the internal surface of the spherical cavity but maintain minimal clearances.

16. A positive displacement motor according to claim 11, wherein the disk includes wedge formations provided on either side of the vane such that the apex of the wedge formation is proximate the hinge connection with the vane.

17. A positive displacement minor according to claim 11, wherein the cavity inlet and outlet open to the variable volume chambers when the chambers are at their minimum and maximum volumes respectively.

18. A positive displacement motor according to claim 11, wherein the cavity inlet and outlet are in the plane defined by the axis of rotation of the inner housing and the diameter of the disk that intersects the axis of rotation of the inner housing at right angles.

19. A thermal engine including:
a positive displacement compressor having at least one rotatable vane partly defining at least one of the variable volume chambers within the compressor;
a thermal chamber in fluid communication with the outlet of the compressor;
the thermal chamber having heat transfer means for transferring heat from a heat source to the working fluid; and,
a positive displacement motor having at least one rotatable vane partly defining at least one of the variable volume chambers within the motor and drive means for driving the compressor and an external load;
wherein, in use the flow of working fluid through the thermal chamber is substantially continuous; and
wherein the positive displacement compressor and/or positive displacement motor are in a accordance with claim 11.

20. A positive displacement compressor including:
an outer casing having internal partition means defining a high pressure zone and a low pressure zone within the casing and a casing inlet and easing outlet in fluid communication with the high and low pressure zones respectively;
an inner housing rotatably mounted within the outer casing, the inner housing having a coupling means for operative connection to a drive shaft and an at least partially spherical cavity disposed within the housing such that a central axis of the cavity is colinear with the axis of rotation of the housing, the cavity having a cavity inlet and cavity outlet in fluid communication with the high pressure zone and low pressure zone respectively;
at least three rotatable vanes mounted within the cavity to define at least two variable volume chambers, one of the three vanes being a central vane rotatably mounted within the cavity for rotation about an axis normal to the plane of the central vane;
the remaining two vanes being side vanes mounted either side of the central vane for rotation about a common axis that passes through the centre of the cavity and the plane of the central vane, the common axis being inclined to the axis of rotation of the inner housing:
the inner housing further having bearing means for relative rotation between the side vanes and the inner housing such that the reactive forces between the side vanes and the inner housing are transferred through the bearing means;
wherein the cavity inlet and cavity outlet are positioned relative to the bearing means such that in use, the cavity inlet is in fluid communication with one of the chambers as its volume is increasing and the cavity outlet is in fluid communication with the other chamber as its volume is decreasing.

21. A positive displacement compressor according to claim 20, wherein said central vane comprises a disc and wherein the drive shaft rotates the inner housing such that the compressor inlet communicates with the low pressure zone of the outer casing and the compressor outlet communicates with the high pressure zone of the outer casing.

22. A positive displacement compressor according to claim 20 and claim 28 wherein the bearing means is an axial thrust bearing race.

23. A positive displacement compressor according to any one of claims 20 to 22, wherein the side vanes are provided by a disk such that one half of the disk is one side vane and the other half is the second side vane, wherein the disk is hinged to the central vane such that the hinge axis is co-linear with the diameter of the central vane.

24. A positive displacement compressor according to claim 23, wherein the respective peripheries of the disk and the central vane do not engage the internal surface of the spherical cavity but maintain minimal clearances.

25. A positive displacement compressor according to claim 24, wherein the disk includes wedge formations provided on either side of the vane such that the apex of the wedge formation is proximate the hinge connection with the vane.

26. A positive displacement compressor according to claim 25, wherein the cavity inlet and outlet open to the variable volume chambers when the chambers are at their minimum and maximum volumes respectively.

27. A positive displacement compressor according to any one of claims 20 to 26, wherein the cavity inlet and outlet are in the plane defined by the axis of rotation of the inner housing and the diameter of the disk that intersects the axis of rotation of the inner housing at right angles.

28. A positive displacement compressor including:
an outer casing having internal partition means defining a high pressure zone and a low pressure zone within the casing and a casing inlet and casing outlet in fluid communication with the high and low pressure zones respectively;
an inner housing rotatably mounted within the outer casing, the inner housing having a coupling means for operative connection to a drive shaft and an at least partially spherical cavity disposed within the housing, the cavity having a cavity inlet and cavity outlet in fluid communication with the high pressure zone and low pressure zone respectively;
at least three rotatable vanes mounted within the cavity to define at least two variable volume chambers, one of the three vanes being a central vane rotatably mounted within the cavity for rotation about an axis normal to the plane of the central vane;
the remaining at least two vanes being side vanes mounted on the central vane for rotation about a common axis;
wherein the cavity inlet and cavity outlet are positioned relative to the bearing means such that in use, the cavity inlet is in fluid communication with one of the chambers as its volume is increasing and the cavity outlet is in fluid communication with the other chamber as its volume is decreasing; and wherein the arrangement for support of said at least 3 rotatable vanes is such that none of said at least 3 vanes forms a load bearing seal with said at least partially spherical cavity.
